(19) United States
(12) Patent Application Publication
(10) Pub. No.: US 2008/0158805 A1
(43) Pub. Date: Jul. 3, 2008

(54) SMALL PORTABLE MULTIPURPOSE PC UNIT INSERTABLE INTO A MULTITUDE OF OPERATING STATIONS

(76) Inventor: Mazen Waheeb El Bteddini, Jabel Ali (LB)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/616,518

(22) Filed: Dec. 27, 2006

(51) Int. Cl. G06F 1/16

(52) U.S. Cl. 361/683

(57) ABSTRACT

The present invention relates to computer unit designed for a multitude of possible usage in various situations and purposes. The said characterized in that it can be easily inserted/detached from different work stations and consists mainly of a small compact computer unit having substantially small dimensions. The said unit consists of casing having a top surface (1) left and right sides (6) and front side (2). The unit of the invention includes two layers inside the casing, the first layer includes modified mother board of the outlet port (10) which joins all the input/output ports of the motherboard into one adapter unit for easy installation into workstations. The second layer is made of heat conductive metal and attached to the processor, VGA, and other chips to absorb the heat generated and expand the surface area through grooved air channels.

### BACKGROUND OF THE INVENTION

The present invention relates to the computer and in particular to computer unit designed for a multitude of possible usage in various situations and purposes.

Many computer designs such as desktops, portable computer, such as a laptop or notebook computer, a sub notebook computer, a personal digital assistant, a wireless phone or the like, have been servicing the world for the past few years, all of which have their special purposes and characteristics but also have many real-life limitations. Consumers are consistently forced to purchase more and more computers to service their daily activities, a Computer for the home, computer for office, a laptop for being on the move, PC tablets and personal entertainment handhelds, in addition to many other accessories. All of which cost the user hard earned money while not giving the users the freedom of working on a single familiar computer everywhere they tend to be in order to better service their needs.

### SUMMARY OF THE INVENTION

The present invention has been developed to eliminate the above mentioned disadvantages to the users. According to one aspect of the present invention, a specially designed computer small enough to be easily transportable between a multitude of locations to be inserted into specially designed docking stations for use at home in the office as a portable laptop in a car or as a handheld unit. According to another aspect of the invention a specially designed casing which keeps the parts cooled.

According to another aspect of the invention a specially designed outlet port extension unit which allows for easy insert and removal from docking stations.

Another aspect of the invention is an outlet port converter which may be used to connect this unit of the present invention to standard interface units available in the market such as Monitors, Plug and play devices using USB, keyboard, mouse, modems, network cables, audio devices and many other devices all included within the scope of this invention since the invention is not restricted to the specific devices mentioned above which are merely given as an examples not to limit the scope of the invention thereto.

Another aspect of the invention a custom designed portable adapter with built in UPS protection for the unit.

Another aspect of the invention, an optional specially designed cooling fan, which works on forced air and uses a cylindrical turbine which propels the cooling air through a maze of air passages in the case.

### SUMMARY OF THE DRAWINGS

FIG. 1 is a diagram Illustrates use capabilities of the new unit of the present invention.

FIG. 2 is a perspective view showing the front side of the unit of the invention.

FIG. 3 is a perspective view showing the back side of the unit of the invention.

FIG. 4 is a frontal view of the Unit show casing the error monitor display and the CD insert section.

FIG. 5 is a side view of the unit showing the case design for inserting into stations. Showing partial part of the air feed vent.

FIG. 6 is a back view showing unit output ports and air ventilation opening.

FIG. 7 is a diagram showing details of the Outlet ports.

FIG. 8 is a diagram showing outlet extension devices.

FIG. 9 is a diagrams showing inside layer one of the unit of this invention.

FIG. 10 is a bottom View of Layer 2 of unit showing cooling system design.

FIG. 11 is a top view of Layer 2 showing CD Ram unit.

### DETAILED DESCRIPTION

The invention will described now with reference to the accompanied drawing for better understanding.

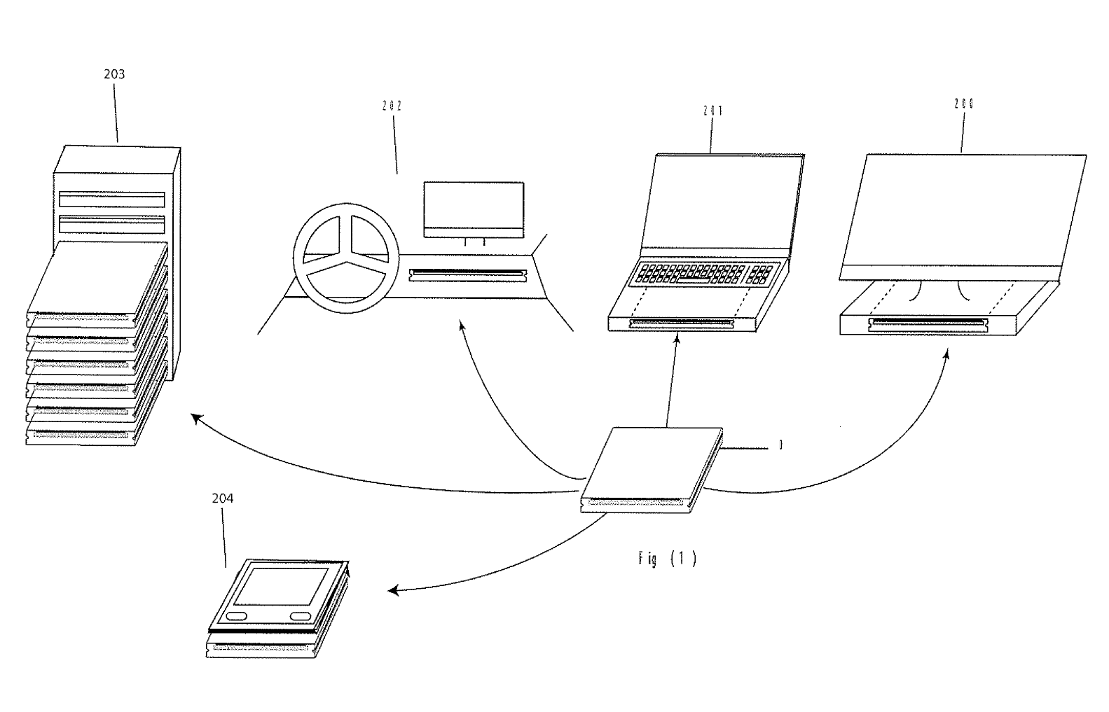

FIG. 1 is a diagram illustrating use capabilities of the unit of the invention (0) which may be connected by insertion and may be detached from different work stations, e.g., desktop (200), portable computer (201), or vehicle work station (202). The unit of the present invention (0) is a special PC unit which is unique in that it Joins certain parts of desktop computer with laptop computer parts. This allows for the reduction of the unit in size so that it can be inserted or removed easily from work stations. Once the PC unit of the invention (0) is inserted into the desktop work station (200) it becomes and operates exactly the same way as a normal desktop computer. Moreover, once the PC unit of the invention (0) is inserted into the portable computer (201) it becomes a fully operational mobile computer (201) with higher processing speed equal to that of a stationary desktop unit. In addition, once the PC unit of the invention (0) is inserted into the vehicle work station unit (202) it becomes a fully operational computer unit inside the vehicle with desktop capabilities. Also, a multitude of the PC unit of invention (0) are inserted into a server station (203) they become fully operational and becomes the part of a network server or a super computer which can process the network requests jointly i s or separately. This PC unit can also be inserted into a portable interface unit (204) which makes it possible to utilize the invention (0) while functioning as a PDA (Portable Digital Adapter).

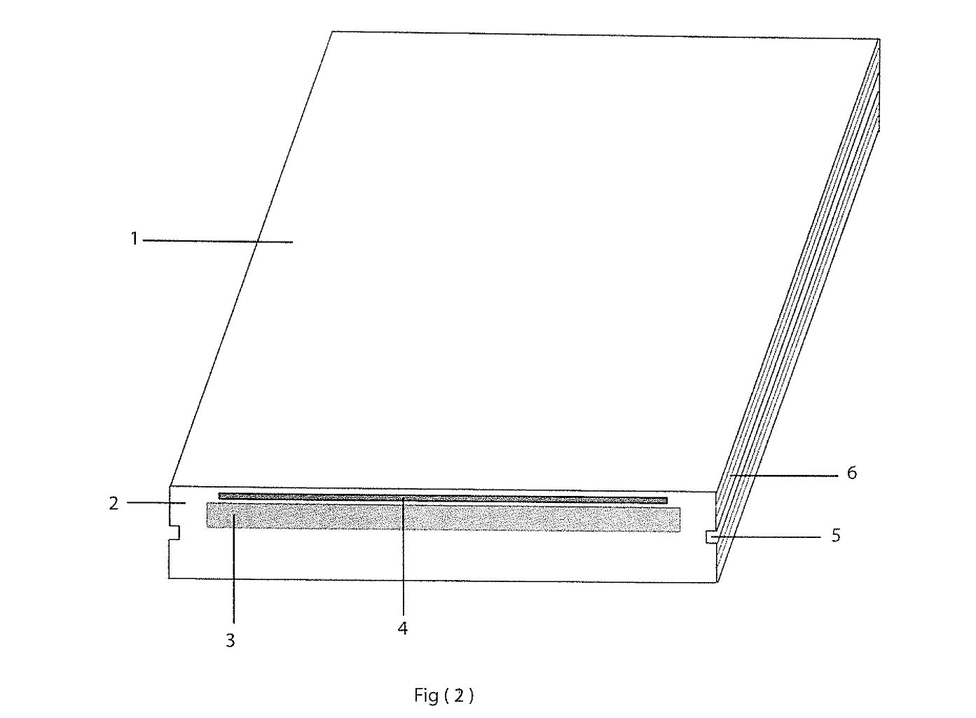

FIG. 2 shows the whole unit of the present invention (0) which consists mainly of a small compact computer unit having dimensions substantially small in comparison to the average dimensions of computers today. The major characteristic of the PC unit of the invention (0) is that it operates with all available features of a standard computer unit. The unit of the invention consists of a casing having a top surface (1) and right sides (6) and front side (2). The casing of the unit is made of heat absorbing metals, e.g. aluminum, copper, titanium, etc. Heat absorbing metals have been specifically chosen to facilitate cooling of the main PC unit (0). Top surface (1) is a flat surface to allow easy insertion of the main PC unit (0) into various work stations. To enhance the simple form and simplify use of the PC unit (0), there is an opening slot (4) found within the front side (2) for CD Rom unit. Below the CD slot (4), there is status monitor (3) which gives a visual signal to the user of the status of the main computer port connections signaling the failure of ports to user. On the right side (6) there is a linear grooves parallel to each other designed to increase surface area in order to allow further coolinig of the main PC unit (0). On both sides of the casing (right and left sides (6)) there is a rectangular slot (5) to allow easy sliding and engagement of the PC unit (0) once it is inserted into any work station.

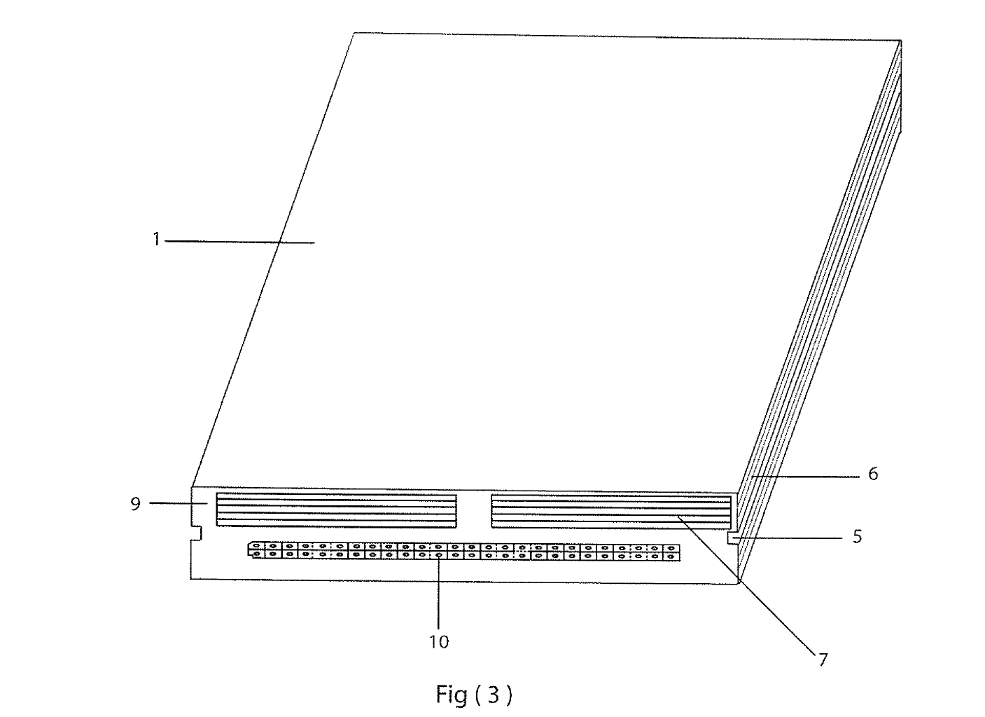

Reference is now made to FIG. 3 represent perspective view showing the back side of the unit of the invention. Within the back side of the unit (9), there is two ventilation openings (7) for inflow and outflow of air to and from the interior of the unit intended for cooling purposes. Below the ventilation openings (7) is the main port attachment slot (10) which comprises of all the standard computer ports, joined all together in a form which allows the present invention main PC unit (0) to be connected quickly and easily into all and any work station (200-201-202).

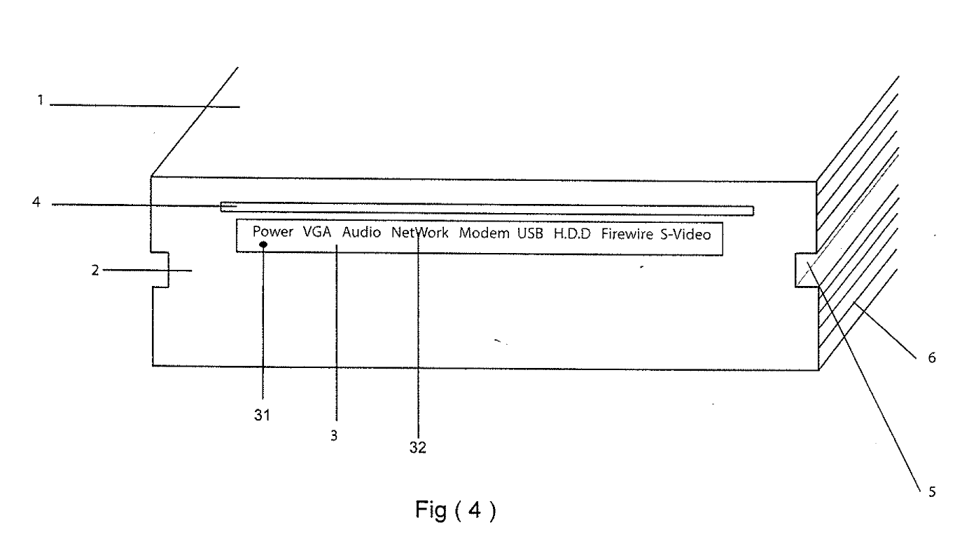

FIG. 4 Shows a detailed view of the front side of the present invention PC unit (0). Front view of the unit shows CD slot (4), below which there is display monitor (3) which is a visual signal indicate the connection status to alert the user of a possible disconnection upon inserting the main PC unit (0) into workstations. This display monitor is made of a transparent material through which the visual signals only show upon being lit up or activated by errors. An example of errors which will display (32) shows the standard naming of the port such as VGA, Audio, Network, Modem, USB, H.D.D., Fire wire, S-Video, etc. In the mean time, the LED light (31) shows the on or off status of the PC unit.

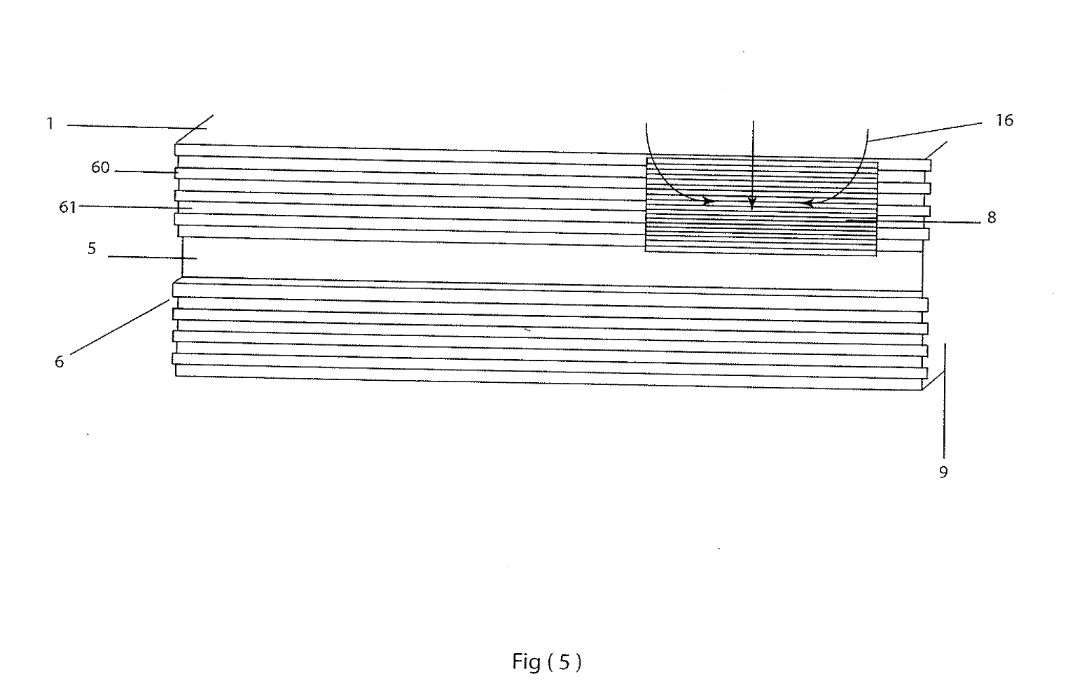

FIG. 5 shows a side view of the present invention PC unit (0). The unit of the invention is stabilized once placed into a workstation through the inset groove (5) which will allow the unit to be inserted in a sliding manner much like a drawer, the unit of the invention is kept in place and prevented from becoming loose or shifting once in position. The side (6) also is comprised of several small grooves (60-61) along the entire side which assist in expanding the area of the metal body and also allows air to flow through the channels to cool the metallic case which is attached to the heat generating parts in the present invention such as the processor and the VGA chip. The side (6) will also comprises an air vent opening (8) which will either draw in air or blow out air depending on which side the fan is installed on.

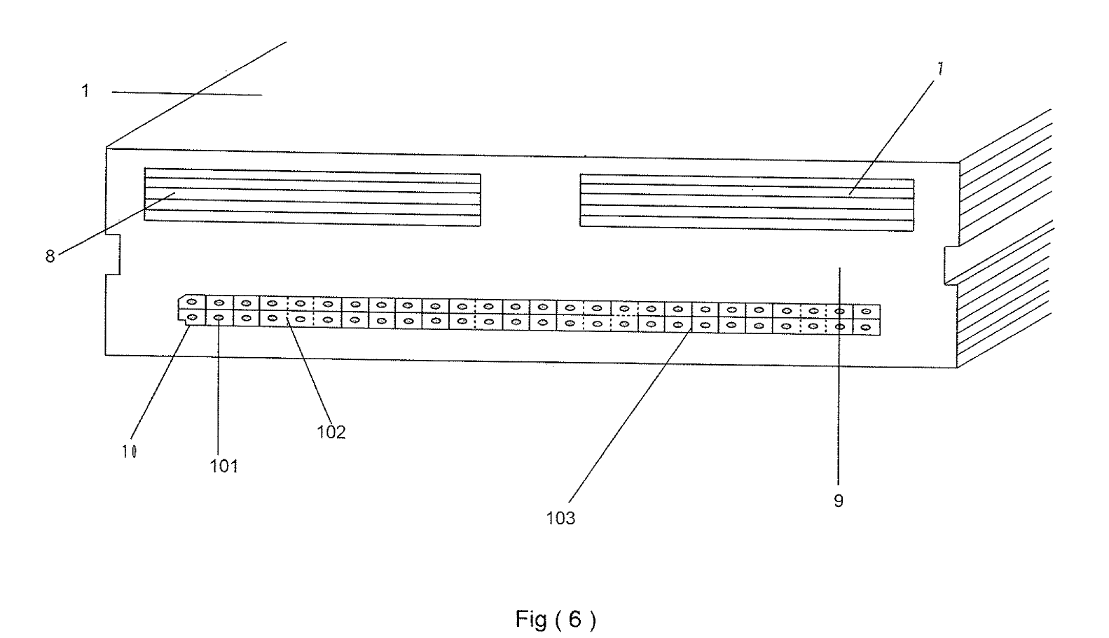

FIG. 6 shows a detailed view of the back of the unit of the present invention showing the arrangement of the outlet adapter (10), which is made of metallic conductors (101) and plastic ribs (103) which will help protect the metallic conductors as the unit is removed and inserted into different workstations. The adapter is designed to fit in a male/female joining format fashion. This outlet is attached directly to the mother board in place of the standard outlets.

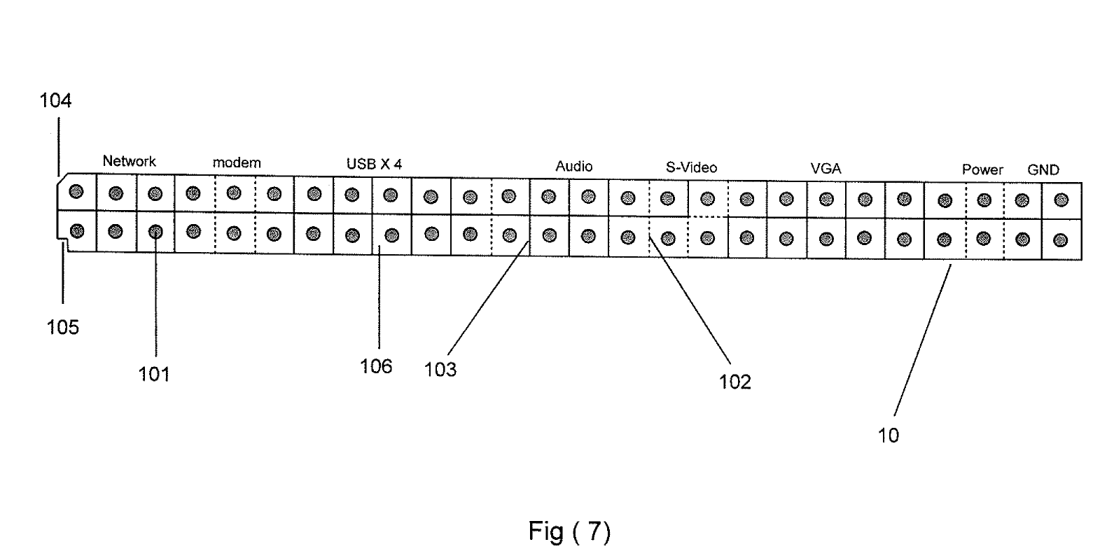

FIG. 7 shows the exact distribution of ports within the outlet unit (10) on the back side of the unit to assist in the insert and installation of the unit and to make sure that the user does not insert the outlet adapter in a wrong fashion (104) and (105) which will also prevent the wrong insertion of the main PC unit into the workstation units or wrong outlet adapters to be attached to the main PC unit (0). Arrangement of outlet port connectors in the adapter is shown in FIG. 7. As shown in FIG. 7, ports arranged from left to right to include ports for Network, modern, USB. Audio, S-Video, VGA, Power and GND respectively.

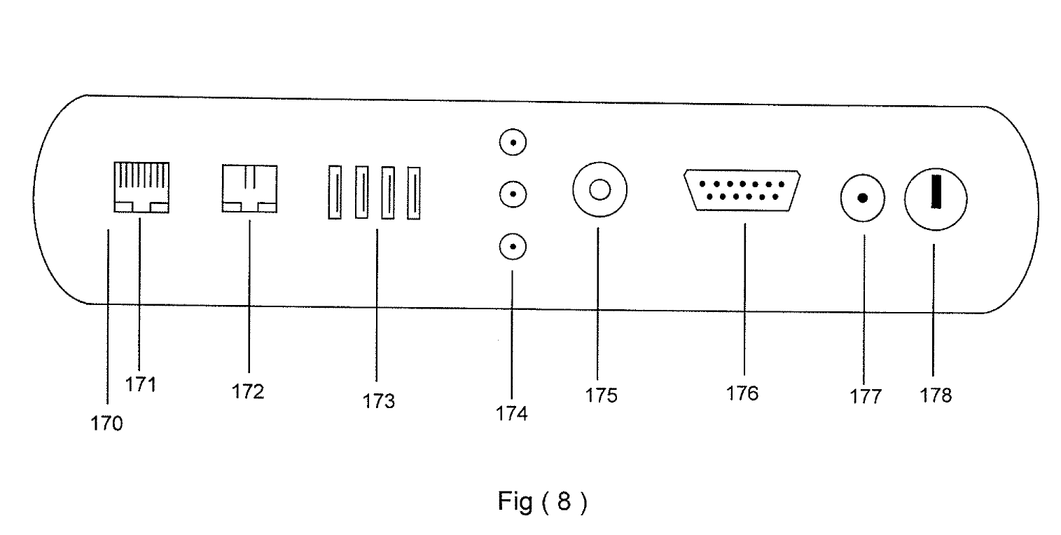

FIG. 8 shows an external outlet adapter unit (170) which can be attached to the main PC unit outlet (10) and will allow the main PC unit (0) to be utilized with standard hardware in the market and thus use of the unit is not restricted to only the workstations (200-201-202) developed for the main PC unit (0). As indicated above, ports are arranged to include the network port adapter (171); the modem (172); USB ports (173), audio and microphone (174), S-Video (175); VGA port (176); Power Supply (177) and power oil button (178).

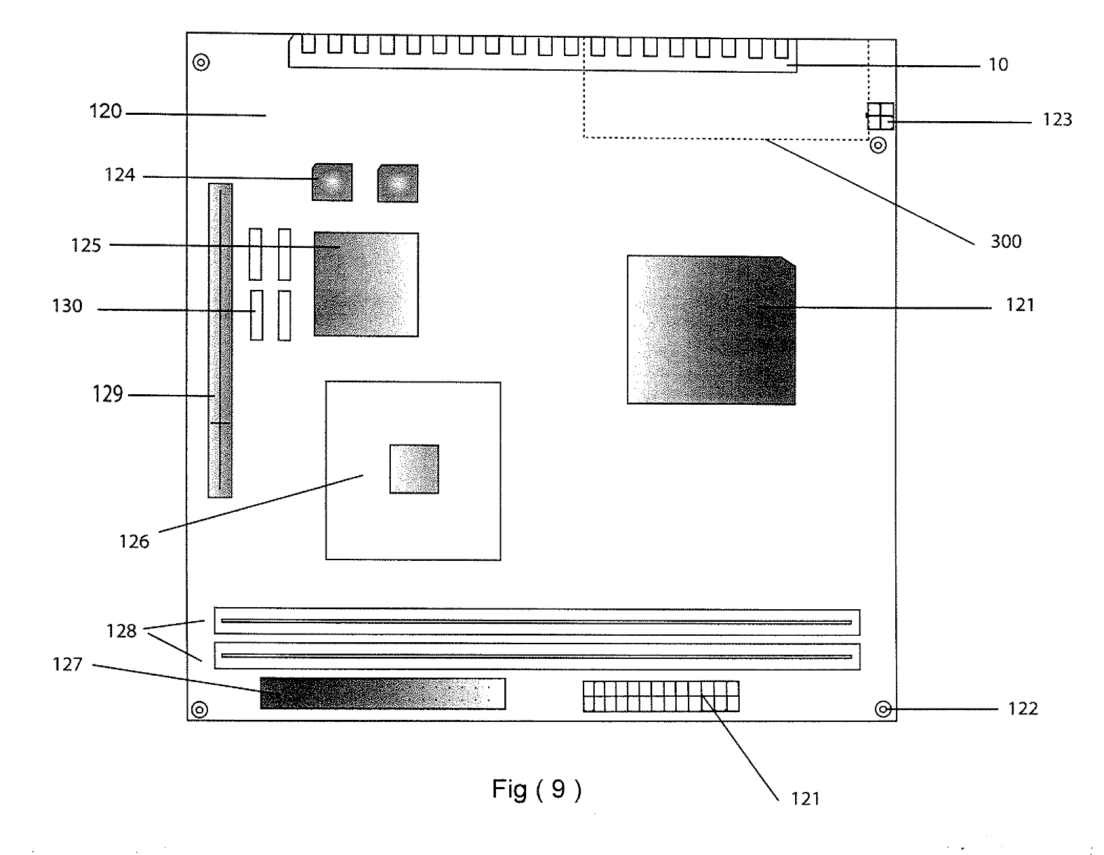

FIG. 9 shows the mother board modification of the outlet port (10) which joins all the input/output ports of the motherboard into one adapter unit for easy installation into workstations. FIG. 9 shows the processor (121), VGA chip (126), and other chips (124-125-130) which will require cooling by fan unit (300). Inlet (123) is an AXT or power connection. There is screw holes (122) whereas screws are inserted in the holes to fix the mother board (1 20). Other slots includes PCI slot (129), this slot is used to inset the network or modem cards. Another slot is slot (128) which is DIMM or RAM slot whereas memory card is inserted. IDE connector or IDE cable connectors (127) are used to connect CD ROM and hard disk.

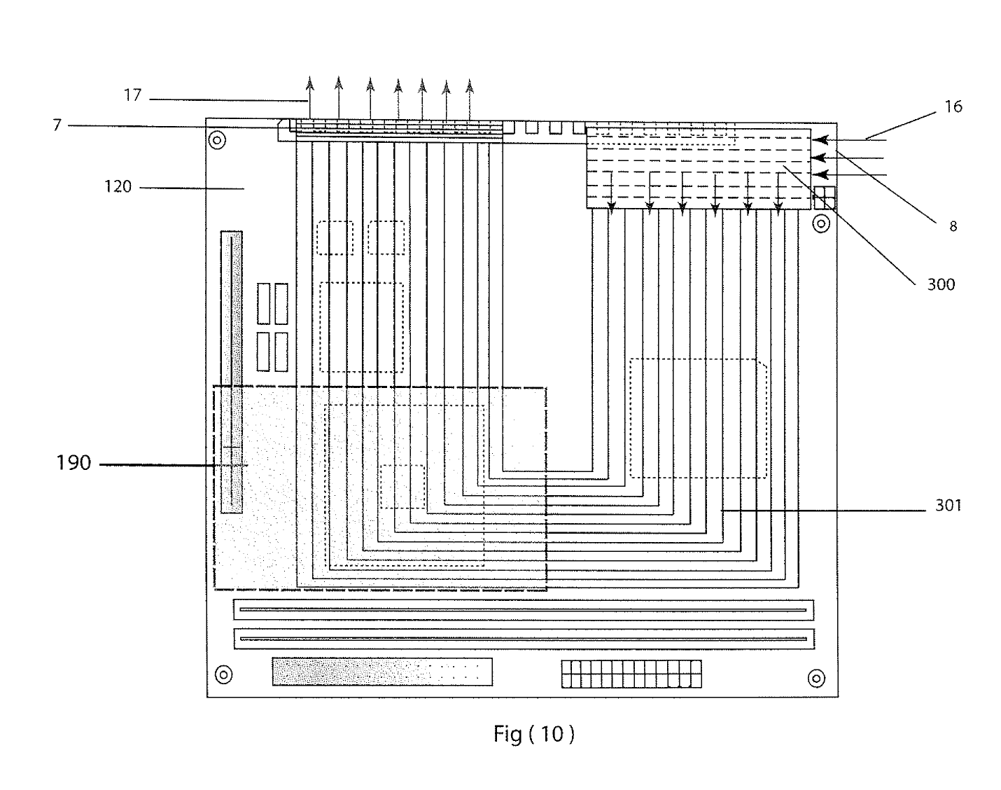

FIG. 10 shows the second layer of the present invention made of heat conductive metal and is attached to the processor (121), VGA (126), and other chips (130) to absorb the heat generated and expand the surface area through grooved air channels (301) which will lead the air introduced by the fan unit (300) and channel it into a maze like form to lead the air into the case from the air input vent (16) and out through the output vent (302). And air vent openings (7 and 8). The arrow (17) shows the passage of the air to and from around the mother board (120) and the hard disk (190). Passage of the air at the other end is indicated by the arrow (302).

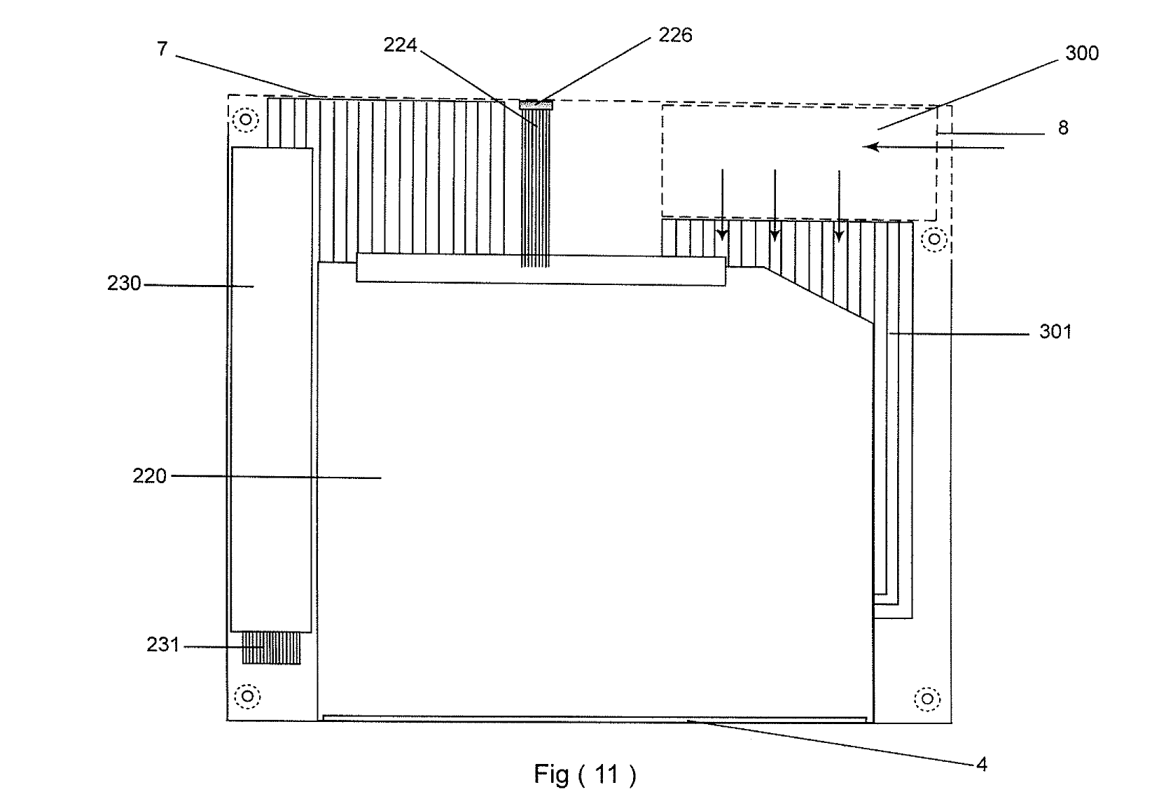

FIG. 11 shows the second layer the air channels (301) of the present invention serves as a base for the CD ROM unit (220) and the power converter chip which distributes the power to motherboard. FIG. 11 shows CD slot (4), fan unit (300), air channels (301) and air vent openings (7 and 8). Power may be supplied through two alternative sources; accordingly, power may either be supplied through AC Power supply (230) or battery (231). In the preferred embodiment of the invention, there is a CD ROM (220), however, the existence of the said CD ROM is optional.

The invention is described by means of a particular example or examples. However, the use of such examples is illustrative only and in no way limits the scope and meaning of the invention or of any exemplified term. Likewise, the invention is not limited to any particular embodiments described herein. Indeed, many modifications and variations of the invention will be apparent to those skilled in the art upon reading this specification and can be made without departing from its spirit and scope. The invention is therefore to be limited only by the terms of the appended claims along with the full scope of equivalents to which the claims are entitled.

1. A portable multipurpose PC unit characterized in that it can be easily inserted/detached from different work stations and consists mainly of a small compact computer unit having substantially small dimensions.

2. A portable multipurpose PC unit wherein it consists of casing having a top surface (1) left and right sides (6) and front side (2).

3. The portable multipurpose PC unit according to claim 2, wherein the casing of the unit is made of heat absorbing metals, e.g. aluminuin, copper, titanium, etc.

4. The portable multipurpose PC unit according to claim 2, wherein the top surface is flat to facilitate inserting the unit into the work station.

5. The portable multipurpose PC unit according to claim 2, wherein on the left and right sides there is a linear grooves parallel to each other to increase surface area and provide cooling of the main PC unit. On both sides there is a rectangular slot (5) to allow easy sliding and engagement of the PC unit (0) once it is inserted into any work station.

6. The portable multipurpose PC unit according to claim 2, whereas on the front side of the unit there is CD slot (4), below which there is display monitor (3) which is a visual signal indicate the connection status to alert the user of a possible disconnection upon inserting the main PC unit (0) into workstations.

7. The portable multipurpose PC unit according to claim 2, whereas on the back side of the unit outlet adapter (10) which is made of metallic conductors (101) and plastic ribs (103) are arranged.

8. A portable multipurpose PC unit comprising a casing wherein there are two layers inside the casing, the first layer includes modified mother board of the outlet port (10) which joins all the input/output ports of the motherboard into one adapter unit for easy installation into workstations and the second layer is made of heat conductive metal and attached to the processor, VGA, and other chips to absorb the heat generated and expand the surface area through grooved air channels.

9. The portable multipurpose PC unit according to claim 1, which includes a cooling system having of cooling fan, air inlets and outlets and a maze of a maze of air passages.

10. The portable multipurpose PC unit according to claim 1, wherein once it is inserted into the work station it becomes and operates exactly the same way as a normal desktop computer.

11. The portable multipurpose PC unit according to claim 1, wherein it joins certain parts of desktop computer with laptop computer parts.

12. The portable multipurpose PC unit according to claim 2, which includes a cooling system having of cooling fan, air inlets and outlets and a maze of a maze of air passages.

13. The portable multipurpose PC unit according to claim 2, wherein once it is inserted into the work station it becomes and operates exactly the same way as a normal desktop computer.

14. The portable multipurpose PC unit according to claim 2, wherein it joins certain parts of desktop computer with laptop computer parts.

15. The portable multipurpose PC unit according to claim 8, which includes a cooling system having of cooling fan, air inlets and outlets and a maze of a maze of air passages.

16. The portable multipurpose PC unit according to claim 8, wherein once it is inserted into the work station it becomes and operates exactly the same way as a normal desktop computer.

17. The portable multipurpose PC unit according to claim 8, wherein it joins certain parts of desktop computer with laptop computer parts.

18. A portable multipurpose PC units according to claim 1, wherein once it is inserted into vehicle work station unit, it becomes a fully operational computer unit inside the vehicle with desktop capabilities.

19. A portable multipurpose PC units according to claim 1, wherein once inserted into a server station they become fully operational and becomes the part of a network set up or a super computer which can process the network requests jointly or separately.

20. A portable multipurpose PC unit according to claim 1, wherein once it is inserted into a portable interface unit, which makes it possible to utilize the invention while functioning as a PDA (Portable Digital Adapter).
